(19) United States
(12) Patent Application Publication
(10) Pub. No.: US 2013/0117744 A1
(43) Pub. Date: May 9, 2013

(54) METHODS AND APPARATUS FOR PROVIDING HYPERVISOR-LEVEL ACCELERATION AND VIRTUALIZATION SERVICES

(71) Applicant: OCZ Technology Group, Inc., San Jose, CA (US)

(72) Inventors: Yaron KLEIN, Ra'anana (IL); Allon COHEN, Los Altos, CA (US); Michael Chaim SCHNARCH, Or Yehuda (IL); Shimon TSALMON, Kfar-Sava (IL); Oded David ILAN, Ra'anana (IL)

(73) Assignee: OCZ TECHNOLOGY GROUP, INC., San Jose, CA (US)

(21) Appl. No.: 13/666,305

(22) Filed: Nov. 1, 2012

Related U.S. Application Data
(60) Provisional application No. 61/555,145, filed on Nov. 3, 2011.

(51) Int. Cl. G06F 9/455

(52) U.S. Cl. CPC G06F 9/45533
USPC 718/1

(57) ABSTRACT

Systems and methods for maintaining cache synchronization in network of cross-host multi-hypervisor systems, wherein each host has least one virtual server in communication with a virtual disk, an adaptation layer, a cache layer governing a cache and a virtualization and acceleration server to manage volume snapshot, volume replication and synchronization services across the different host sites.

### CROSS REFERENCE TO RELATED APPLICATIONS

This application claims the benefit of U.S. provisional application No. 61/555,145 filed Nov. 3, 2011, the contents of which are herein incorporated by reference.

### TECHNICAL FIELD

The present invention relates to acceleration and virtualization services of virtual machines, such as replication and snapshots.

### BACKGROUND

Data center virtualization technologies are now well adopted into information technology infrastructures. As more and more applications are deployed in a virtualized infrastructure, there is a growing need for performance acceleration, virtualization services, and business continuity at various levels.

Virtual servers are logical entities that run as software in a server virtualization infrastructure, also referred to as a “hypervisor”. A hypervisor provides storage device emulation, also referred to as “virtual disks”, to virtual servers. A hypervisor implements virtual disks using back-end technologies, such as files on a dedicated file system, or maps raw data to physical devices.

As distinct from physical servers that run on hardware, virtual servers execute their operating systems within an emulation layer that is provided by a hypervisor. Virtual servers may be implemented in software to perform the same tasks as physical servers. Such tasks include, for example, execution of server applications, such as database applications, customer relation management (CRM) applications, email servers, and the like. Generally, most applications that are executed on physical servers can be programmed to run on virtual servers. Virtual servers typically run applications that service a large number of clients. As such, virtual servers should provide high performance, high availability, data integrity and data continuity. Virtual servers are dynamic in the sense that they are easily moved from one physical system to another. On a single physical server the number of virtual servers may vary over time, with virtual machines added and removed from the physical server.

Conventional acceleration and virtualization systems are not designed to handle the demands created by the virtualization paradigm. Most conventional systems are not implemented at the hypervisor level to use virtual servers and virtual disks, but instead are implemented at the physical disk level. As such, these conventional systems are not fully virtualization-aware.

Because computing resources, such as CPU and memory, are provided to the virtual server by the hypervisor, the main bottleneck for the virtual server's operation resides in the storage path, and in particular the actual storage media, e.g., the magnetic hard disk drives (HDDs). An HDD is an electromechanical device and as such, performance, especially random access performance, is extremely limited due to rotational and seek latencies. Specifically, any random access READ command requires an actuator movement to position the head over the correct track as part of a seek command, which then incurs additional rotational latencies until the correct sector has moved under the head.

Another type of media storage is a solid state disk or device (SSD), which is a device that uses solid state technology to store its information, and provides access to the stored information via a storage interface. An SSD may use NAND flash memory to store the data, and a controller that provides regular storage connectivity (electrically and logically) to flash memory commands (program and erase). Such a controller can use embedded SRAM, additional DRAM memory, battery backup and other elements.

Flash based storage devices (or raw flash) are purely electronic devices, and as such do not contain any moving parts. Compared to HDDs, a READ command from flash device is serviced in an immediate operation, yielding much higher performance especially in the case of small random access read commands. In addition, the multi-channel architecture of modern NAND flash-based SSDs results in sequential data transfers saturating most host interfaces.

Because of the higher cost per bit, deployment of solid state drives faces some limitations in general. In the case of NAND flash memory technology, another issue that comes into play is limited data retention. It is not surprising, therefore, that cost and data retention issues along with the limited erase count of flash memory technology are prohibitive for acceptance of flash memory in back-end storage devices. Accordingly, magnetic hard disks still remain the preferred media for the primary storage tier. A commonly used solution, therefore, is to use fast SSDs as cache for inexpensive HDDs.

Because the space in the cache is limited, efficient caching algorithms must make complex decisions on what part of the data to cache and what not to cache. Advanced algorithms for caching also require the collection of storage usage statistics over time for making an informed decision on what to cache and when to cache it.

Virtualization services, such as snapshots and remote replication are available on the storage level or at the application level. For example, the storage can replicate its volumes to storage at a remote site. An application in a virtual server can replicate its necessary data to an application at a remote site. Backup utilities can replicate files from the virtual servers to a remote site. However, acceleration and virtualization services outside the hypervisor environment suffer from inefficiency, lack of coordination between the services, multiple services to manage and recover, and lack of synergy.

An attempt to resolve this inefficiency leads to a unified environment of acceleration and virtualization in the hypervisor. This provides an efficient, simple to manage storage solution, dynamically adaptive to the changing virtual machine storage needs and synergy. Accordingly, the hypervisor is the preferred environment to place the cache, in this case an SSD.

To help with efficient routing of data through hypervisors, the hypervisor manufacturers allow for hooks in the hypervisor that enable inserting filtering code. However, there are strong limitations on the memory and coding of the inserted filter code. This would limit today's caching solutions from inserting large amounts of logic into the hypervisor code.

### SUMMARY

Certain embodiments disclosed herein include a cross-host multi-hypervisor system which includes a plurality of accelerated and optional non-accelerated hosts which are connected through a communications network configured to synchronize migration of virtual servers and virtual disks from one accelerated host to another while maintaining coherency of services such as cache, replication and snapshots. In one embodiment, each host contains at least one virtual server in communication with a virtual disk, wherein the virtual server can read from and write to the virtual disk. In addition, each host site has an adaptation layer with an integrated cache layer, which is in communication with the virtual server and intercepts cache commands by the virtual server to the virtual disk, the cache commands include, for example, read and write commands.

Each accelerated host further contains a local cache memory, preferably in the form of a flash-based solid state drive. In addition, to the non-volatile flash memory tier, a DRAM-based tier may yield even higher performance. The local cache memory is controlled by the cache layer which governs the transfer of contents such as data and metadata from the virtual disks to the local cache memory.

The adaptation layer is further in communication with a Virtualization and Acceleration Server (VXS), which receives the intercepted commands from the adaptation layer for managing volume replication, volume snapshots and cache management. The cache layer, which is integrated in the adaptation layer, accelerates the operation of the virtual servers by managing the caching of the virtual disks. In one embodiment, the caching includes transferring data and metadata into the cache tier(s), including replication and snapshot functionality provided by the VXS to the virtual servers.

In one embodiment, the contents of any one cache, comprising data and metadata, from any virtual disk in any host site in the network can be replicated in the cache of any other host in the network. This allows seamless migration of a virtual disk from any between host without incurring a performance hit since the data are already present in the cache of the second host.

The VXS further provides cache management and policy enforcement via workload information. The virtualization and acceleration servers in different hosts are configured to synchronize with each other to enable migration of virtual servers and virtual disks across hosts.

Certain embodiments of the invention further include a hypervisor for accelerating cache operations. The hypervisor comprises at least one virtual server; at least one virtual disk that is read from and written to by the at least one virtual server; an adaptation layer having therein a cache layer and being in communication with at least one virtual server, wherein the adaptation layer is configured to intercept and cache storage commands issued by the at least one virtual server to the at least one virtual disk; and at least one virtualization and acceleration server (VXS) in communication with the adaptation layer, wherein the VXS is configured to receive the intercepted cache commands from the adaptation layer and manage perform at least a volume replication service, a volume snapshot service, and a cache volume service, and cache synchronization between a plurality of host sites.

Certain embodiments of the invention further include a method for synchronizing migration of virtual servers across a plurality of host computers communicatively connected through a network, wherein each host computer has at least one virtual server connected to at least one virtual disk, an adaptation layer in communication with the at least one virtual server and with a virtualization and acceleration server (VXS). The method comprises intercepting cache commands from the at least one virtual server to the virtual disk by the adaptation layer; communicating the intercepted cache commands from the adaptation layer to the virtualization and acceleration server; and performing, based on the intercepted cache commands, at least a volume replication service, a volume snapshot service, a cache volume service and synchronizing cache between the plurality of host computers.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a block diagram of a hypervisor architecture designed according to one embodiment.

FIG. 2 is a detailed block diagram illustrating the modules of the hypervisor depicted in FIG. 1.

FIG. 3 is a flowchart illustrating the data flow of the cache layer in the adaptation layer for a read command flow from the virtual servers toward the virtual disks according to one embodiment.

FIG. 4 is a flowchart illustrating the data flow of the cache layer in the adaptation layer, for a read command callback arriving from the virtual disk toward the virtual server according to one embodiment.

FIG. 5 is a flowchart illustrating the handling of a write command received from a virtual server toward the virtual disk by the cache layer according to one embodiment.

FIG. 6 is a flowchart illustrating the operation of the replication module in the VXS for handling a volume replication service according to one embodiment.

FIG. 7 is a flowchart illustrating the operation of the snapshot module in the VXS for handling a snapshot replication service according to one embodiment.

FIG. 8 is a flowchart illustrating the operation of the cache manager module in the VXS according to one embodiment.

FIG. 9 illustrates a cross-host multi-hypervisor system.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality in the drawings; like numerals refer to like parts through several views.

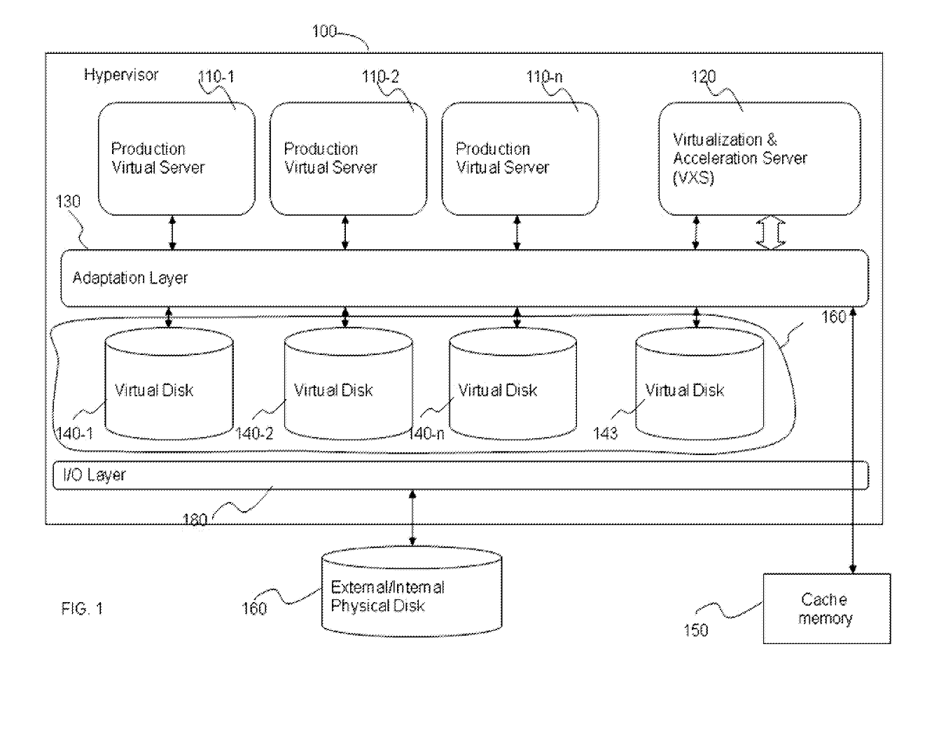

FIG. 1 shows a simplified block diagram of a hypervisor 100 designed according to one embodiment disclosed herein. The architecture of the hypervisor 100 includes an adaptation layer 130, a dedicated virtualization and acceleration server (VXS) 120, and a plurality of production virtual servers 110-1 through 110-n (collectively referred to as virtual server 110). Each virtual server 110 is respectively connected to at least one virtual disk 140-1, 140-2, through 140-n, and the VXS 120 is connected to at least one dedicated virtual disk 143. All the virtual disks 140-1, 140-n and 143 reside on an external physical disk 160. Each virtual disk is a virtual logical disk or volume to which a virtual server 110 (or VXS 120) performs I/O operations. A cache memory 150 is also connected to the adaption layer 130. The cache memory 150 may be a flash based storage device including, but not limited to a SATA, SAS or PCIe based SSD which can be integrated into the accelerated host or be an external (attached) drive, for example using eSATA, USB, Intel Thunderbolt, OCZ HSDL, DisplayPort, HDMI, IEEE 1394 FireWire, Fibre channel or high speed wireless technology.

In the hypervisor 100, the data path establishes a direct connection between a virtual server (e.g., server 110-1) and its respective virtual disk (e.g., 140-1). According to one embodiment, the adaptation layer 130 is located in the data path between the virtual servers 110 and the virtual disks 140-1, 140-n, where every command from a virtual server 120 to any virtual disk passes through the adaptation layer 130.

The VXS 120 is executed as a virtual server and receives data from the adaptation layer 130. The VXS 120 uses its own dedicated virtual disk 143 to store relevant data and metadata (e.g., tables, logs).

The cache memory 150 is connected to the adaptation layer 130 and utilized for acceleration of I/O operations performed by the virtual servers 110 and the VXS 120. The adaptation layer 130 utilizes the higher performance of the cache memory 150 to store frequently used data and fetch it upon request (i.e., cache).

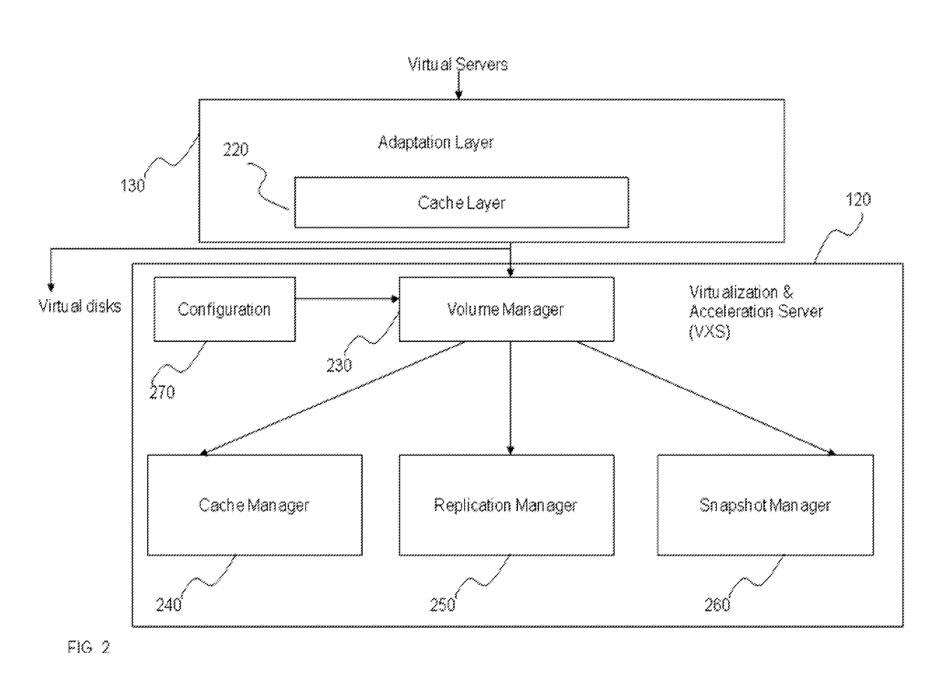

An exemplary and non-limiting block diagram of the adaptation layer 130 and VXS 120 and their connectivity is illustrated in FIG. 2. The adaptation layer 130 includes a cache layer 220 that manages caching of data from the virtual disks 140-1, 140-n in the cache memory 150. A commonly used terminology could also say that the cache layer “caches” data from the virtual disks in the cache memory. The cache layer 220 provides its metadata including mapping tables to map the space of the virtual disks 140-1, 140-n to the space of the cache memory 150. The cache layer 220 further maintains statistics information regarding data frequency and other information. The cache layer 220 handles only necessary placement and retrieval operations to provide fast execution of data caching.

In one embodiment, the cache layer 220 can assign a RAM media as a faster tier (to the flash media 150) to provide a higher level of caching. The cache layer 220 manages data caching operation all data in the data path, including data from the virtual servers 110 to the virtual disks 140-1, 140-n and also from the VXS 120 to its virtual disk 143. Hence, acceleration is achieved to the data path flowing between virtual disks and virtual servers and also to the virtualization functionality provided by the VXS 120. In another embodiment, the cache layer 220 governs caching of specific virtual disks requiring acceleration as configured by the user (e.g., a system administrator). In yet another embodiment, the cache layer 220 can differentiate between the caching levels via assignment of resources, thus providing Quality of Service (QoS) for the acceleration.

The VXS 120 includes a volume manger 230, a cache manager 240, a replication manager 250, and a snapshot manager 260. The VXS 120 receives data cache commands from the adaptation layer 130. The data cache commands are first processed by the volume manager 230 that dispatches the commands to their appropriate manager according to a-priori user configuration settings saved in the configuration module 270. For better flexibility and adaptation to any workload or environment, the user can assign the required functionality per each virtual disk 140-1, 140-n. As noted above, a virtual disk can be referred to as a volume.

The VXS 120 can handle different functionalities which include, but are not limited to, volume replication, volume snapshot and volume acceleration. Depending on the required functionality to a virtual disk 140-1, 140-n, as defined by the configuration in the module 270, the received data commands are dispatched to the appropriate modules of the VXS 120. These modules include the replication manager 250 for replicating a virtual disk (volume), a snapshot manager 260 for taking and maintaining a snapshot of a virtual disk (volume), and a cache manager 240 to manage cache information (statistics gathering, policy enforcement, etc,) to assist the cache layer 220.

The cache manager 240 is also responsible for policy enforcement of the cache layer 220. In one embodiment, the cache manager 240 decides what data to insert the cache and/or to remove from the cache according to an a-priori policy that can be set by a user (e.g., an administrator) based on known, for example and without limitation, user activity or records of access patterns. In addition, the cache manager 240 is responsible for gathering statistics and performing a histogram on the data workload in order to profile the workload pattern and detect hot zones therein.

The replication manager 250 replicates a virtual disk (140-1, 140-n) to a remote site over a network, e.g., over a WAN. The replication manager 250 is responsible for recording changes to the virtual disk, storing the changes in a change repository (i.e., a journal) and transmitting the changes to a remote site upon a scheduled policy. The replication manager 250 may further control replication of the cached data and the cache mapping to one or more additional VXL modules on one or more additional physical servers located at a remote site. Thus, the mapping may co-exist on a collection of servers allowing transfer or migration of the virtual servers between physical systems while maintaining acceleration of the virtual servers. The snapshot manager 260 takes and maintains snapshots of virtual disks 140-1, 140-n which are restore points to allow for restoring of virtual disks to each snapshot.

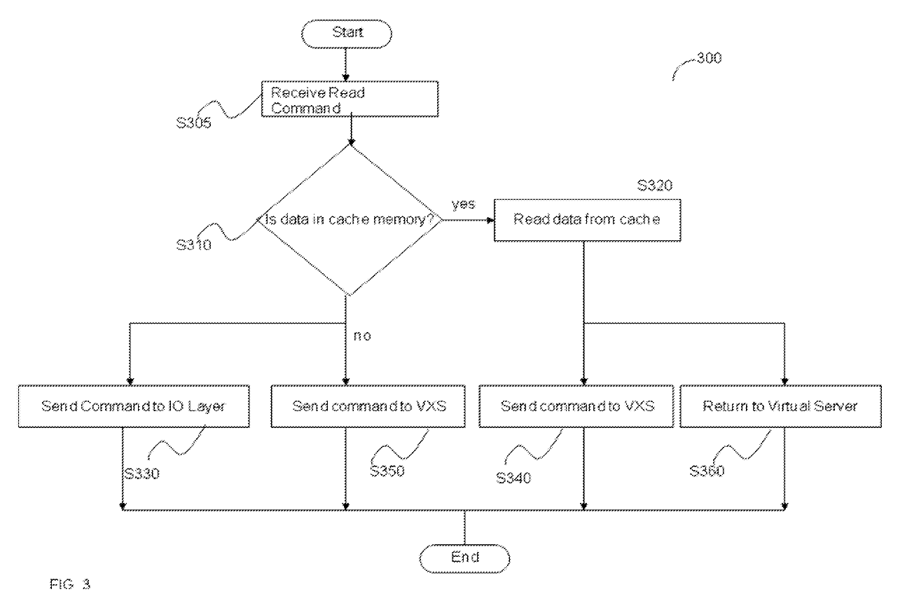

An exemplary and non-limiting flowchart 300 describing the handling of a read command issued by a virtual server to a virtual disk is shown in FIG. 3. At S305, a read command is received at the adaptation layer 130. At S310, the cache layer 220 performs a check to determine if the received data command is directed to data residing in the cache memory 150. If so, at S320, the adaptation layer 130 executes a fetch operation to retrieve the data requested to be read from the cache memory. Then, at S360, the adaption layer returns the data to the virtual server and in parallel, at S340, sends the command (without the data) to the VXS for statistical analysis.

If S310 returns a No answer, i.e., the data requested in the command do not reside in the cache, the received read command is passed, at S330, to the virtual disk via the IO layer and in parallel, at S350, to the VXS 120 for statistical analysis.

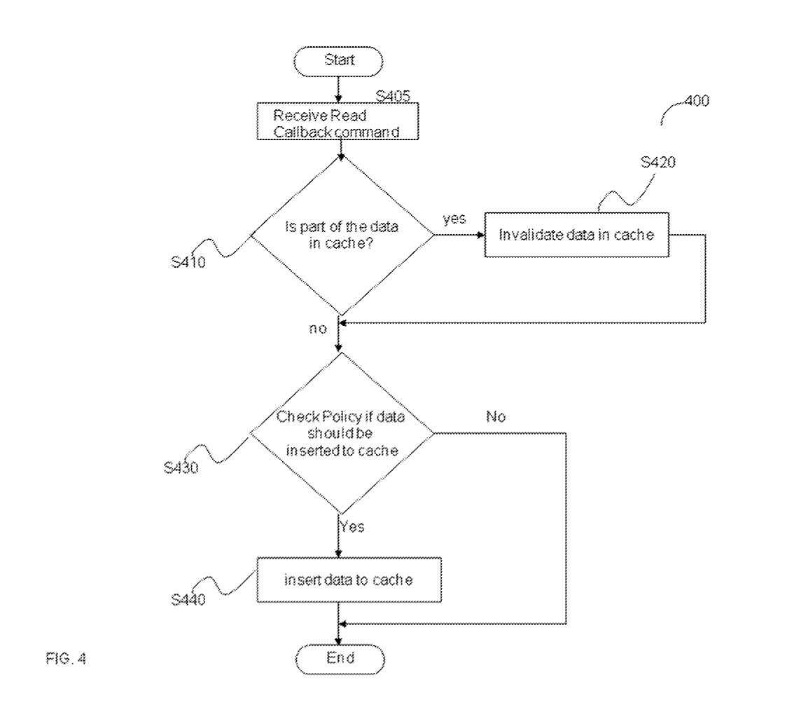

An exemplary and non-limiting flowchart 400 for handing of a read callback when data to a read command are returned from the virtual disk to the virtual server is shown in FIG. 4. The flowchart 400 illustrates the operation of the cache layer in an instance of a cache miss. At S405, a read command's callback is received at the adaptation layer 130 from the virtual disk. At S410, a check is made to determine if part of the data fetched from the virtual disk (140-1, 140-n) resides in the cache, and if so at S420, the cache layer 220 invalidates the respective data in the cache and then proceeds to S420. Otherwise, at S430, the cache layer 220 checks whether the data received should be inserted into the cache according to the policy rules set by the cache manager 240. The rules are based on the statistics gathered in the cache manager 240, the nature of the application, the temperature of the command's space (i.e., is it in a hot zone) and more. If so, at S440, the cache manager inserts the data to the cache and continues with the data to one of the virtual servers 110. Otherwise, if the rules specify that the data should not be inserted in the cache it continues to the virtual server without executing a cache insert.

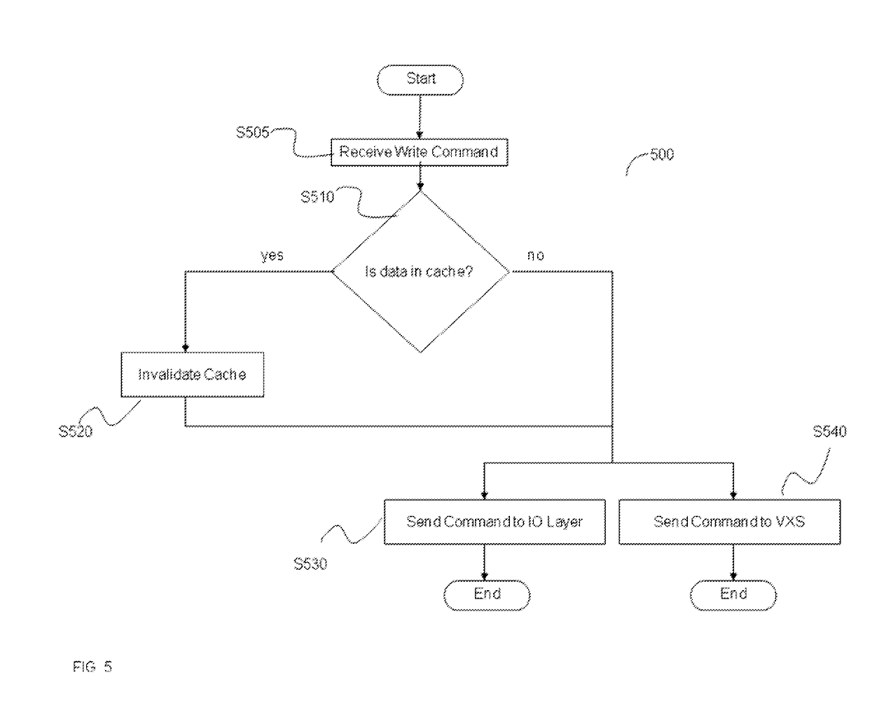

FIG. 5 shows an exemplary and non-limiting flowchart 500 illustrating the process of handling of a write command by the cache layer 220 according to one embodiment. At S505, a write command is received at the cache layer 220 in the adaptation layer 130. The write command is issued by one of the virtual servers 110 and is directed to its respective virtual disk. The write command is sent from the virtual server to the adaptation layer 130.

At S510, it is checked if the data to be written as designated in the write command reside in the cache memory 150. If so, at S520 the respective cached data are invalidated. After the invalidation, or if it was not required, the write command is sent, at S530, through the IO layer 180 to the physical disk 160 and at 3540 to the VXS 120 for processing and update of the virtual disks 140. A write command is processed in the VXS 120 according to the configuration saved in the configuration module 270. As noted above, such processing may include, but are not limited to, data replication, snapshot, and caching of the data.

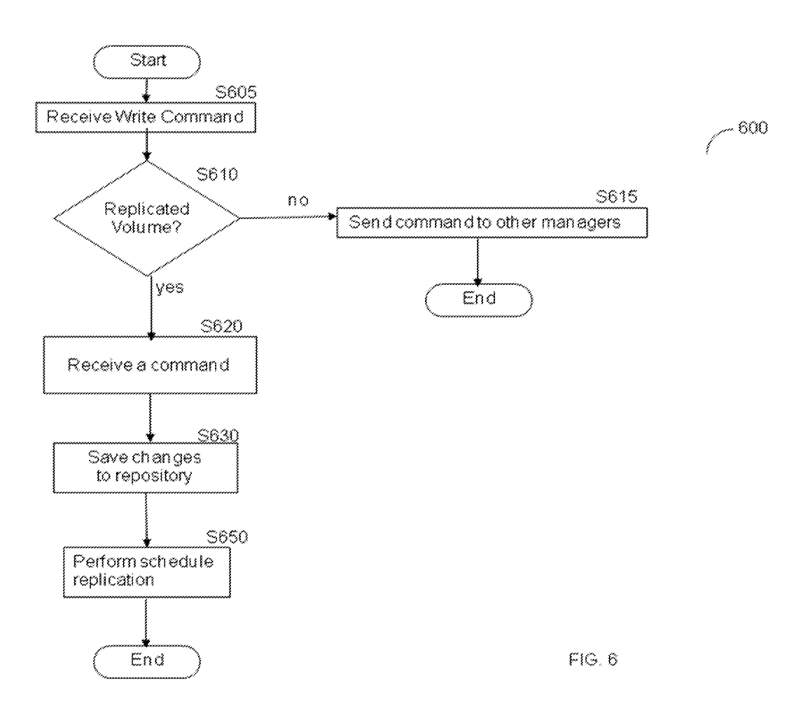

An exemplary and non-limiting flowchart 600 illustrating the operation of the replication manager 250 is shown in FIG. 6. At S605, a write command is received at the volume manger 230, which determines, at S610, if the command should be handled by the replication manager 250. If so, execution continues with S620; otherwise, at S615, the command is forwarded to either the snapshot manager or the cache manager.

The execution reaches S620 where a virtual volume is replicated by the replication manager 250. The virtual volume is in one of the virtual disks 120 assigned to the virtual server from which the command is received. At S630, the replication manager 250 saves changes made to the virtual volume in a change repository (not shown) that resides in the virtual disk 143 of the VXS 120. In addition, the replication manager 250 updates the mapping tables and the metadata in the change repository. In one embodiment, at S640, at a pre-configured schedule, e.g., every day at 12:00 PM, a scheduled replication is performed to send the data changes aggregated in the change repository to a remote site, over the network, e.g., a WAN.

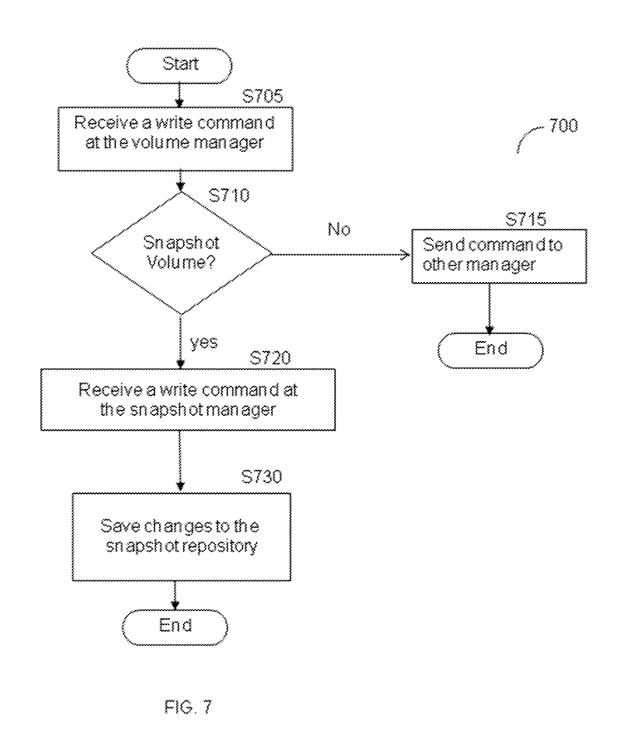

An exemplary and non-limiting flowchart 700 illustrating the operation of the snapshot manager 260 is shown in FIG. 7. At S705, a write command is received at the volume manger 230, which determines, at S710, if the command should be handled by the snapshot manager 260. If so, execution continues with S720; otherwise, at S715, the command is forwarded to either the snapshot manager or the cache manager. As noted above, the volume manger 230 forwards the write command to the snapshot manager 260 based on a setting defined by the user through the module 270.

At S720, the command reaches the volume manager 260 when the volume, i.e., one of the virtual disks, is a snapshot volume. At S730, the snapshot manager 260 saves changes to the volume and updates the mapping tables (if necessary) in the snapshot repository in the virtual disk 143 of the VXS 120.

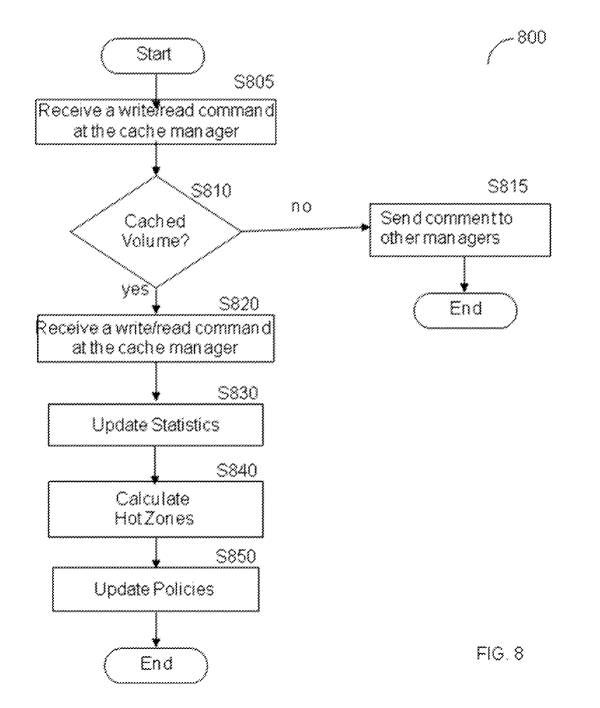

An exemplary and non-limiting flowchart 800 illustrating the operation the cache manager 240 is shown in FIG. 8. At S805, either a read command or a write command is received at the volume manager 230. At S810, it is checked using the configuration module 270 if the command is directed to a cache volume, i.e., one of the virtual disks 140-1, 140-n. If so, execution continues with S820; otherwise, at 815, the command is handled by other managers of the VXS 120.

At S820, the received command reaches the cache manager 240. At S830, the cache manager 260 updates its internal cache statistics, for example, cache hit, cache miss, histogram, and so on. At S840, the cache manager 240 calculates and updates its hot zone mapping every time period (e.g., every minute). More specifically, every predefined time period or interval in which the data are not accessed, their temperature decreases, and, on any new access, the temperature increases again. The different data temperatures can be mapped as zones, for example from 1 to 10 but any other granularity is possible. Then, at S850 the cache manager 240 updates its application specific policies. For example, in an Office environment, a list of frequently requested documents can be maintained and converted into a caching policy for the specific application, which is updated every time a document is accessed.

According to one embodiment, in a plurality of accelerated hosts, VXS units in each accelerated host communicate with each other to achieve synchronization of configurations and to enable migration of virtual servers and virtual disks from one host to another. The host may an accelerated host or a non-accelerated host. That is, the synchronization of configurations may be performed from an accelerated host to a non-accelerated host, or vice versa. As noted above, each accelerated host also includes a local cache memory, preferably in the form of a flash-based solid state drive. In addition to the non-volatile flash memory tier, a DRAM-based tier may yield even higher performance. The local cache memory is controlled by the cache layer which governs the transfer of contents such as data and metadata from the virtual disks to the local cache memory.

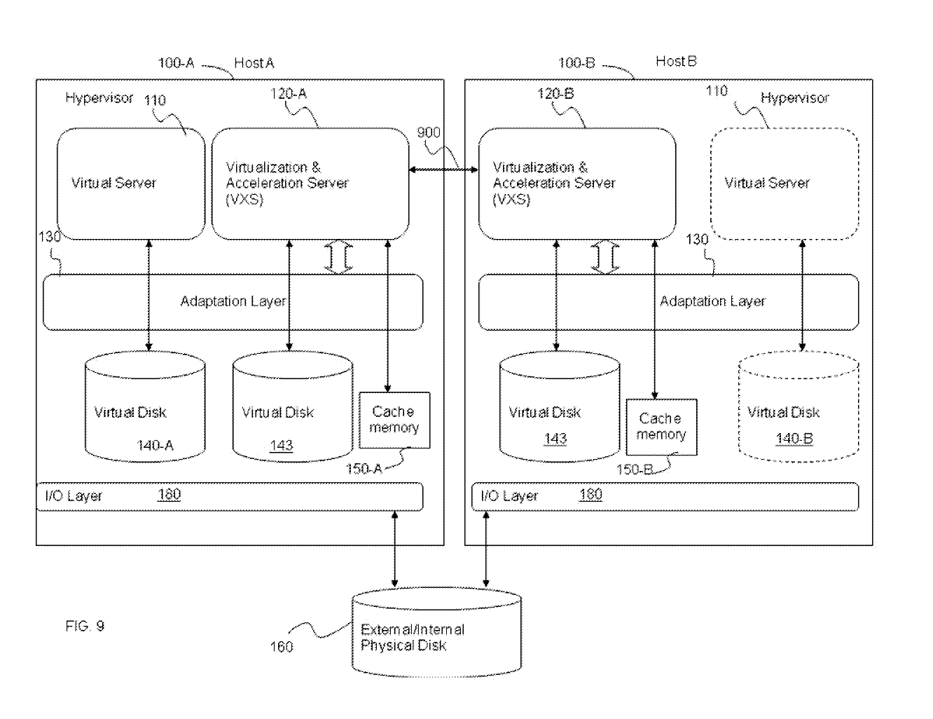

FIG. 9 illustrates an exemplary and non-limiting diagram of a cross-host multi-hypervisor system. As shown in FIG. 9, VXS 120-A of a host 100-A is connected to VSX 120-B of a host 100-B via network connection 900 to achieve synchronization. According to one embodiment, when virtual server 110-A and virtual disk 140-A migrate to host 100-B, the VSX 120-B flushes the cache to achieve coherency.

According to another embodiment, the hosts 100-A and 100-B can also share the same virtual disk, thus achieving data synchronization via the hypervisor cluster mechanism.

The foregoing detailed description has set forth a few of the many forms that the invention can take. It is intended that the foregoing detailed description be understood as an illustration of selected forms that the invention can take and not as a limitation as to the definition of the invention.

Most preferably, the embodiments described herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

What is claimed is:

1. A cross-host multi-hypervisor system, comprising:
a plurality of hosts communicatively connected through a network, each host comprises:
at least one virtual server;
at least one virtual disk that is read from and written to by the at least one virtual server;
an adaptation layer having therein a cache layer and being in communication with at least one virtual server, wherein the adaptation layer is configured to intercept and cache commands issued by the at least one virtual server to the at least one virtual disk; and
at least one virtualization and acceleration server (VXS) in communication with the adaptation layer, wherein the VXS is configured to receive the intercepted cache commands from the adaptation layer and perform, based on the intercepted cache commands, at least a volume replication service, a volume snapshot service, a cache volume service, and cache synchronization between the plurality of hosts.

2. The system of claim 1, wherein the VXS is connected to a virtual disk to provide a repository for the volume replication service, the volume snapshot service, and the cache volume service, and wherein the adaptation layer is connected to a cache memory.

3. The system of claim 1, wherein the cache layer is configured to accelerate the operation of the at least one virtual server caching of the at least one virtual disk.

4. The system of claim 1, wherein the VXS is further configured to synchronize migration of the at least one virtual server and at least one virtual disk from one host to the other host, thereby providing an immediate access to cached data on the other host.

5. The system of claim 2, wherein the VXS further comprises:
a configuration module that includes a predefined configuration with regard to the type of service to apply to each of the at least one virtual disks;
a volume manager configured to receive a cache command that uses the configuration module to direct the cache command based on the type of service defined for the at least one virtual disk designated in the command, wherein the cache command is any one of a read command and a write command;
a cache manager configured to perform the cache volume service;
a replication manager configured to perform the replication volume service; and
a snapshot manager configured to perform the snapshot volume service.

6. The system of claim 5, wherein the replication volume service includes:
receiving a write command from the volume manager;
saving changes designated in the write command to a changes repository in the virtual disk connected to the VXS; and
transmitting the changes stored in the changes repository to a remote host over the network at a predefined schedule.

7. The system of claim 5, wherein the cache volume service includes:
receiving the command from the volume manager;
updating cache statistics;
calculating at predefined time intervals hot zones; and
updating policies related to at least one application.

8. The system of claim 5, wherein the snapshot volume service includes:
receiving a write command from the volume manager; and
saving changes designated in the write command to a snapshot repository in the virtual disk connected to the VXS.

9. The system of claim 1, wherein at least one of the plurality of hosts is an accelerated host, wherein the accelerated host also includes a local cache memory, wherein the local cache memory is at least in a form of a flash-based solid state drive.

10. A hypervisor for accelerating cache operations, comprising:
at least one virtual server;
at least one virtual disk that is read from and written to by the at least one virtual server;
an adaptation layer having therein a cache layer and being in communication with at least one virtual server, wherein the adaptation layer is configured to intercept and cache commands issued by the at least one virtual server to the at least one virtual disk; and
at least one virtualization and acceleration server (VXS) in communication with the adaptation layer, wherein the VXS is configured to receive the intercepted cache commands from the adaptation layer and perform at least a volume replication service, a volume snapshot service, a cache volume service, and cache synchronization between a plurality of hosts.

11. The hypervisor of claim 10, wherein the VXS is connected to a virtual disk to provide a repository for the volume replication service, the volume snapshot service, and the cache volume service, and wherein the adaptation layer is connected to a cache memory.

12. The hypervisor of claim 11, wherein the cache layer is configured to accelerate the operation of the at least one virtual server caching of the at least one virtual disk.

13. The hypervisor of claim 11, wherein the VXS further comprises:
a configuration module that includes a predefined configuration with regard to the type of service to apply to each of the at least one virtual disks;
a volume manager configured to receive a cache command and using the configuration module to direct the cache command to based on the type of service defined for the at least virtual disk designated in the command, wherein the cache command is any one of a read command and a write command;
a cache manager configured to perform the cache volume service;
a replication manager configured to perform the replication volume service; and
a snapshot manager configured to perform the snapshot volume service.

14. The hypervisor of claim 13, wherein the replication volume service includes:
receiving a write command from the volume manager;
saving changes designated in the write command to a changes repository in the virtual disk connected to the VXS; and
transmitting the changes stored in the changes repository to a remote host site over the network at a predefined schedule.

15. The hypervisor of claim 13, wherein the cache volume service includes:
receiving the command from the volume manager;
updating cache statistics;
calculating hot zones at predefined time intervals; and
updating policies related to at least one application.

16. The hypervisor of claim 13, wherein the snapshot volume service includes:
receiving a write from the volume manager; and
saving changes designated in the write command to a snapshot repository in the virtual disk connected to the VXS.

17. A method for synchronizing migration of virtual servers across a plurality of host computers communicatively connected through a network, wherein each host computer has at least one virtual server connected to at least one virtual disk, an adaptation layer in communication with the at least one virtual server and with a virtualization and acceleration server (VXS), comprising:
intercepting cache commands from the at least one virtual server to the virtual disk by the adaptation layer;
communicating the intercepted cache commands from the adaptation layer to the virtualization and acceleration server; and
performing, based on the intercepted cache commands, at least a volume replication service, a volume snapshot service, a cache volume service and synchronizing cache between the plurality of host computers.

18. The method of claim 17, wherein the VXS is connected to a virtual disk to provide a repository for the volume replication service, the volume snapshot service, and the cache volume service, and wherein the adaptation layer is connected to a cache memory.

19. The method of claim 18, wherein the cache layer is configured to accelerate the operation of the at least one virtual server caching of the at least one virtual disk.

20. The method of claim 17, wherein the synchronization of the host caches results in duplication of cache data and metadata in the cache of the plurality of host computers.

21. The method of claim 20, wherein the replication volume service includes:
receiving a cache command, wherein the cache command is a write command;
saving changes designated in the write command to a changes repository in the virtual disk connected to the VXS; and
transmitting the changes stored in the changes repository to a remote host site over the network at a predefined schedule.

22. The method of claim 20, wherein the cache volume service includes:
receiving a cache command from the volume manager, wherein the cache command is any of a write command and a read command;
updating cache statistics;
calculating hot zones at predefined time intervals; and
updating policies related to at least one application.

23. The method of claim 20, wherein the snapshot volume service includes:
receiving a cache command, wherein the cache command is a write command; and
saving changes designated in the write command to a snapshot repository in the virtual disk connected to the VXS.

24. A non-transitory computer readable medium having stored thereon instructions for causing one or more processing units to execute the method according to claim 19.
